(19) United States
(12) Patent Application Publication
(10) Pub. No.: US 2024/0211788 A1
(43) Pub. Date: Jun. 27, 2024

(54) QUANTUM-HARDENED POWER GRID

(71) Applicant: ColdQuanta, Inc., Boulder, CO (US)

(72) Inventors: Pranav Gokhale, Chicago, IL (US); Michael A. Perlin, Chicago, IL (US); Palash Goiporia, Chicago, IL (US); Frederic T. Chong, Chicago, IL (US); William Clark, Gilbert, AZ (US)

(21) Appl. No.: 18/391,190

(22) Filed: Dec. 20, 2023

Related U.S. Application Data
(60) Provisional application No. 63/434,346, filed on Dec. 21, 2022.

(51) Int. Cl. G06N 10/20

(52) U.S. Cl. CPC G06N 10/20

(57) ABSTRACT

A quantum-hardened power grid includes grid nodes (e.g., power plants, renewable energy sources and substations) and transmission lines connecting the grid nodes. The grid nodes include stable quantum clocks that permit the power grid to continue operation in the event of downtime for a GPS or other external synchronization reference. Operation sans an external reference can be extended by synchronizing atomic clocks across grid nodes using a quantum network. The atomic clocks can be used with quantum sensors and quantum computers to provide grid state estimates, e.g., using quantum tomography “at the edge”. In addition, these quantum devices can be used to compute responses to grid faults and cyberattacks.

### CROSS REFERENCE TO OTHER APPLICATIONS

This application claims priority to U.S. Provisional Patent Application No. 63/434,346 entitled ATOMIC CLOCK ENHANCED GRID SECURITY filed Dec. 21, 2022, which is incorporated herein by reference for all purposes.

### BACKGROUND OF THE INVENTION

The reliability of power grids underpins modern industry and daily lives. The power transmission grid for the contiguous United States consists of 300,000 km of lines operated by 500 companies. This power grid operates at reliability levels of over 99.999% availability, exceeding even the uptime of most Internet services. Many critical operations on the power grid are reliant on accurate timekeeping, for instance: AC frequency measurement, (synchro) phasor measurement units (PMUs), and real-time market transactions.

The timekeeping for these operations is provided by courtesy of the US Space Force, which provides public access to Global Positioning System (GPS) signals from satellite-based atomic clocks that allow a modern power grid to keep precise time. However, the reliance on GPS poses a substantial cybersecurity risk to power grids, particularly in light of the relative ease with which cyberattacks can be applied against GPS signals: GPS service can be jammed, spoofed, or even completely destroyed via cyberattacks. Such cyberattacks are already commonplace, with famous incidents ranging from local occurrences at small airports (e.g., Wilmington Airport in North Carolina) to international-scale occurrences such as jamming GPS.

The impact of GPS signal loss in the power grid has been noted by several recent publications examining the susceptibility of Phasor Measurement Units (PMUs), i.e., devices used to estimate the magnitude and phase angle of an electrical phasor quantity (such as voltage or current) in the power grid using a common time source for synchronization. Under IEEE standard C37.118, PMUs must have at most 1% relative error or 0.573 degrees of absolute error in measurements of electrical current phase to ensure safe grid operation. A collaboration between Northrop Grumman and the University of Texas experimentally demonstrated a GPS spoofing attack on a PMU, showing that the IEEE standard's requirements on PMU accuracy could be breached in seconds. This style of attack can cause a generator trip, leading to cascading faults characteristic of events such as the 2003 Northeast Blackout, which caused approximately 90 excess deaths and $6B of economic loss across the US and Canada. Despite attempts to establish sophisticated distributed algorithms for GPS signal loss resilience in the power grid, this susceptibility appears to be a fundamental problem with reliance on GPS. What is needed is an approach to minimize cybersecurity and other risks to power grids.

### BRIEF DESCRIPTION OF THE DRAWINGS

Various embodiments of the invention are disclosed in the following detailed description and the accompanying drawings.

FIG. 1 is a schematic diagram of a quantum-hardened power-grid link.

FIG. 2 is a grey-scale diagram of a quantum-hardened power grid including the link of FIG. 1.

FIG. 3 is a flow diagram of metric processing to assess threats and mapping to TPC/IP stack to improve secure routing for the power grid of FIG. 2.

FIG. 4 is a is a schematic of a contingency analysis task being converted into a Hybrid Multiple Phase Estimation Algorithm (HMPEA).

FIG. 5 is a schematic of a quantum circuit for the HMPEA contingency analysis of FIG. 4.

FIG. 6 is a schematic diagram of a quantum computer system of the power-grid of FIG. 2.

FIG. 7 is a flow chart of a power-grid synchronization process used in the power grid of FIG. 2.

FIG. 8 is a flow chart of a fault-detection process used in the power grid of FIG. 2.

### DETAILED DESCRIPTION

The present invention provides a quantum-hardened power grid with enhanced robustness and resilience to malicious attacks as well as unintentional faults by incorporating quantum technologies including atomic clocks, quantum networks, quantum sensors and/or quantum computers. While each of these quantum technologies provides advantages on their own, they work synergistically together. Cold atoms are an ideal platform for the intersection of quantum sensing and computing. Among other advantages, cold atoms operate at room temperature (only the atoms are “cold”), reducing typical requirements and overhead for edge-deployment. Moreover, the same atomic species can be used for clocks, sensors, and computation, so transduction is only needed with photons in the quantum network.

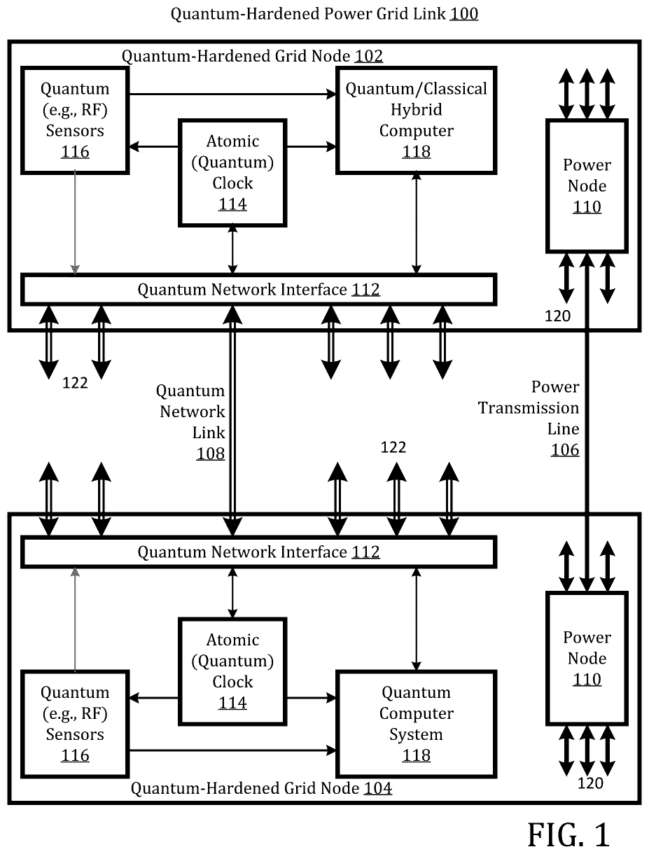

As shown in FIG. 1, a quantum-hardened power grid link 100 includes quantum-hardened grid nodes 102 and 104, a power transmission line 106, and a quantum network link 108. Each quantum-hardened grid node 102, 104 includes a power node 110, a quantum network interface 112, an atomic (aka quantum) clock 114, quantum sensors 116, and a quantum computer system 118.

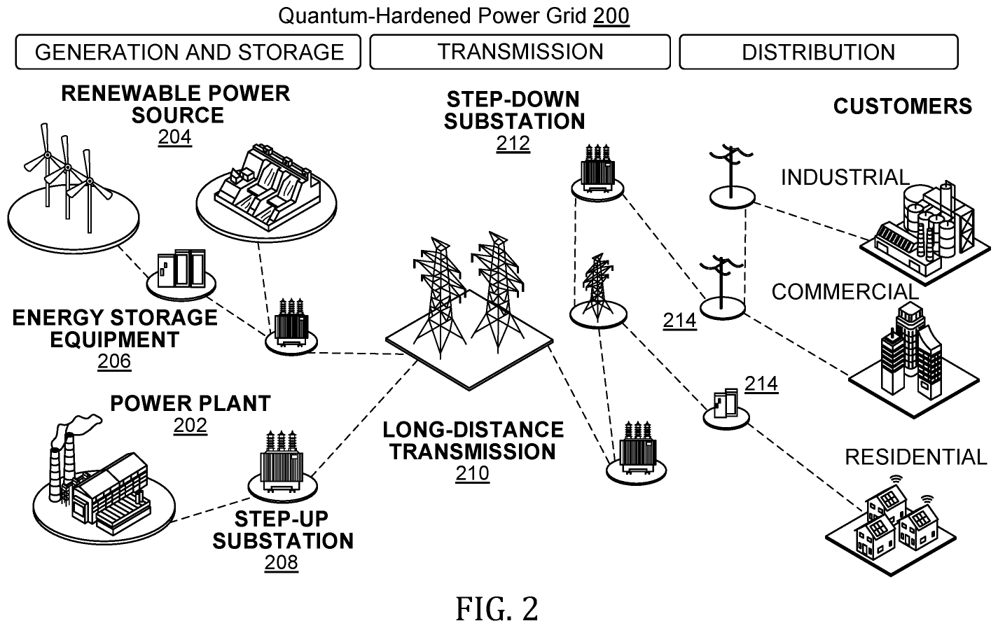

Power transmission line 106 and power nodes 110 can be conventional components of power grids. As indicated in FIG. 2, power nodes 110 of a quantum-hardened power grid 200 can include power plants 202, renewable energy sources 204, energy storage equipment 206, step-up substations 208, long distance transmission substations 210, step-down substations 212, and distribution substations 214 for industrial, commercial, and residential customers. Since power grids are relied on to provide alternating current (AC) power under varying load conditions, they regulate voltage and frequency.

Each of the power nodes 110 (FIG. 1) and each power transmission line 106 is a potential point of failure. Accordingly, a conventional power grid can include measures to detect and respond to failures. One measure is to use many-to-many connections between power nodes. Accordingly, not only are power nodes 110 of grid nodes 102 and 104 connected by power transmission line 106 that connects them, but they are connected to other power nodes by power transmission lines 120 to grid nodes not shown in FIG. 1. Thus, power can be rerouted around failed nodes and transmission lines by switching functions built into the power nodes. The present invention provides for switching among quantum network links 108 and 122 to parallel the switching implemented by power nodes 110. A classical contingency analysis can predetermine switching and other responses to node and/or transmission-line failures.

Since power grids can include thousands of power nodes, the present invention provides for a gradual introduction of quantum components to harden the grid. Accordingly, the present invention provides for enhanced grid hardening by installing atomic clocks, initially at power nodes that can best benefit from their increased precision and then expanding to all power nodes. Likewise, quantum networks, sensors, and computers can be deployed gradually.

To synchronize their classical clocks, conventional grids rely on GPS signals based on atomic clocks that serve as precise measures of time. Accordingly, the present invention provides for installing atomic clocks in power grid nodes. However, atomic clock technology is not only well established but is also developing rapidly as evidenced by the Tiger product line, available from ColdQuanta Inc. of Louisville, Colorado doing business as Infleqtion, that includes products with size, weight, and power (SWaP) advantages as well as lower costs.

An atomic clock installed at a power node can be used to identify variations in transmission line impedance using time-domain reflectometry with orders of magnitude higher precision than can be achieved using a classical timing device. This can, for example, allow transmission line defects to be located to within meters instead of kilometers. Atomic clocks can be orders of magnitude more precise in measuring frequency and thus detecting deviations from target values. As a result, deviations can be detected more quickly and adjustments can be made more precisely, resulting in more stable power line AC frequencies. Thus, droop control and other time-based regulations can be better controlled. Droop control is a process of regulating frequency and voltage of power provided by different power sources (e.g., from power plants and from renewable resources), a regulation process that might otherwise oscillate between power set points. Generally, time-based functions of a power grid can be accomplished with higher sensitivity and greater precision where atomic clocks are used.

Atomic clocks keep track of time by measuring the oscillation frequency between two energy levels of an atom. Atomic clocks are used to define the unit measurement for time (the second) in the standard international (SI) system of units, and, as of 2019, all SI units can trace their physical origins to an atomic clock measurement. The same atomic clock technology that is propagated by GPS signals can instead be deployed directly on the grid through Chip-Scale Atomic Clocks (CSACs) that are commercially available today. In 2016, researchers in Tennessee installed a Chip-Scale Atomic Clock (CSAC) inside of a PMU. Their experimental results validated that the CSAC achieves performance matching timekeeping via GPS signals over several minutes. Moreover, over a 24-hour period, the CSAC timekeeping drifts only 890 ns relative to the GPS signal, which itself is generally accurate to only ˜1000 ns. In other words, current CSACs offer equivalent timekeeping accuracy to GPS signals for up to 24 hours.

As previously mentioned, timekeeping from a GPS reference provides typical accuracy up to 1000 nanoseconds. However, several grid operations can benefit from ultra-accurate timing. One exemplar application is Traveling Wave Fault Detection (TWFD), which can enable utilities to locate faults on the grid up to a precision of a few hundred feet by triangulating from detection events and multiplying time differences by the speed of light.

Another exemplary application is droop control, which can help secure grids against imbalances in AC power. Droop control was originally adopted to operate synchronous generators, and has recently been adopted to operate inverters, often used to connect renewable energy sources to an existing power grid, connected in parallel. Droop control can be conceptualized as a phase-lock loop (PLL) enhanced to provide feedback based on voltage and frequency/phase.

TWFD and droop control have stringent time-keeping accuracy requirements: roughly 100 nanoseconds for 100-foot resolution in TWFD and 500 nanoseconds for droop control. While this level of accuracy cannot be provided by GPS signals, atomic clocks based on optical frequency transitions can achieve and even far surpass these timing requirements. Deployment of optical atomic clocks with 100 nanosecond accuracy can unlock ultra-accurate timing applications that enhance grid security. For example, TWFD can enable grids to react faster to faults (caused by either environmental factors, or malicious cybernetic or physical attacks). Similarly, enhanced droop control can help guard the grid against imbalances.

The atomic clocks can be synchronized as conventional classical clocks using GPS. In the event of a GPS failure, another external synchronization source, e.g., from StarLink services (available from Space X) can be used. In the absence of an external synchronization source, the stability of atomic clocks can allow them to carry forward their most recent synchronization for days and even months, depending on the particular atomic clocks employed. However, sufficient synchrony among the clocks for PMU purposes may be lost in about a day without GPS. On the other hand, the atomic clocks can be connected by quantum networks, enabling new synchronization protocols that further guard against GPS signal loss by extending synchrony indefinitely.

Regardless of the accuracy of individual clocks, an uncertainty would remain in terms of synchronization between spatially separated clocks. Clocks on the grid can be unentangled and only synchronized by classical signals. However, in the context of quantum networks, (a) obviation of GPS timing reference and (b) asymptotically better synchronization by using two quantum features of photons, i.e., entanglement and squeezing, can be achieved. If the classical uncertainty in synchronization between two clocks is ϵ, then the uncertainty can be reduced by a factor of \sqrt{MN} when M entangled pulses, each carrying N squeezed photons are used. M=14 photons have been entangled in experiments to date.

The atomic clocks in the grid can be connected by a quantum network to enable enhanced synchronization between clocks. The key enabling technology for this phase is the deployment of quantum networks. The result is a grid that is completely resilient to GPS signal loss. Moreover, enhanced clock synchronization can also lead to further enhanced positioning accuracy for tasks such as TWFD. Accuracy for this task improves from hundreds of feet to a few inches, equipping power grids with geolocation tools to precisely and rapidly respond to attacks and outages.

Even better synchronization has been achieved by the Illinois Express Quantum Network that extends 50 miles from Argonne National Laboratory to Fermilab in the Chicago area. To test the synchronicity of two clocks—one at Argonne and one at Fermilab—scientists transmitted a traditional clock signal and a quantum signal simultaneously between the two clocks. The signals were sent over the Illinois Express Quantum Network. Researchers found that the two clocks remained synchronized within a time window smaller than 5 picoseconds, i.e., 5 trillionths of a second.

As shown in FIG. 1, atomic clocks 114 are coupled bi-directionally to respective quantum network interfaces 112. Thus, an atomic clock 114 on the grid can serve as a primary clock to the remaining secondary clocks for synchronization purposes. Quantum interfaces 112 can encode photons with time stamps prior to transmission in accordance with a quantum-time transfer (QTT) protocol. To avoid dependence on a fixed primary clock, a primary clock can be selected at any time based on a comparison of clock timing data across grid nodes; for example, a clock with a median time base cannot have lagged or led by too much and so would be a good primary clock candidate. Unselected atomic clocks could then synchronize to the selected primary. Using this internal synchronization method, synchronous operation can be extended indefinitely even in the absence of external synchronization. Since atomic clocks are synchronized to a primary clock with a timing that is an average (e.g., mean, median) of the atomic clocks 114, all atomic clocks 114 deviate less from standard time. This means that the maximum error for time-based measurement is reduced and that fault locations using TWFD, TDR or triangulation can be accurate to within centimeters rather than meters.

A combination of QTT and tagging, and discrete-variable (DV) and continuous-variable (CV) forms of entanglement can be used to detect and accurately identify rogue/counterfeit nodes, attempts to inject routes into the network, and eavesdropping (see Table 1). For Quantum Time Transfer (QTT), the extremely tight time correlations from time-energy entangled photon pairs from Spontaneous Parametric Down Conversion (SPDC) source can be used for QTT.

The QTT protocol is based on a two-way optical method using a SPDC pair source at each network node. By tagging the arrival times of the signal photons from each source and calculating the cross-correlation with the locally tagged associated idler photons, the time and frequency offsets between the two clocks can be measured. In addition, the time of flight between the two nodes can be calculated with better than nano-second (ns) precision. Such timing precision enables the detection of any abnormal delays over point-to-point and peer-to-peer links, as well as the capability of discerning the slight differences in timing between entangled signal and idler pairs in DV and CV channels, and the ability to resolve frequency and polarization dispersion over fiber optic links.

In addition to the high precision of the QTT protocol, the use of the fundamentally random timing of the SPDC pair production process as the time signal ensures that no adversary can easily spoof the signal. In addition, by utilizing additional DV entanglement, e.g., in polarization, between the down converted photon pairs, the timing signals can be authenticated by entanglement witness using quantum bit error rate, Q-BER thresholds or CHSH violation. (The CHSH inequality, named after the authors Clauser, Horne, Shimony, and Holt, is used to experimentally prove Bell's theorem (1969). This theorem asserts that local hidden variable theories cannot account for some consequences of entanglement in quantum mechanics.) As such, QTT is well suited to detecting the potential presence of rogue nodes, eavesdropping and route injections.

TABLE 1
TA2 Quantum Augmentation, Benefits & Metrics.

| | Classical | Quantum | | Algorithmic |
|---|---|---|---|---|
| Metric | Limitation | Augmentation | Benefit | Measures |
| Node | ARP (IPv4), | Covert | Use of covert Quantum | 1) DV Q-BER |
| Verification | SNDP (IPv6) | Quantum | channel to transmit | 2) CV C-BER |
| | susceptible to | communications | unique node | 3) Compare of |
| | spoofing, | over CV | identification; | node IDs |
| | MTM and DoS | channel | compare with | |
| | attacks | | traditional ARP, SNDP | |
| | | | results to reveal | |
| | | | presence of rogue | |
| | | | nodes | |
| Detect | Ability to hide | High | Use of Quantum time | 1) Physical, 2) |
| Route | within time | resolution | transfer and tagging to | datalink and 3) |
| Injection | variations | Quantum time | detect physical, link & | network packet |
| | between | transfer | network packet time | anomalies |
| | routes | across point- | anomalies, to flag | breaking threshold |
| | | to-point links | route injection | (ns) & objective |
| | | | | (10 ps) limits |
| Detect | Ability to | Monitor one | Use of multiple | 1) DV Q-BER |
| Unwanted | sample | or more DV | entanglement | 2) CV C-BER over |
| Listeners | without | and/or CV | modalities to detect & | CV channel with |
| | detection | channels | vet decoherence | one-way |
| | | across point- | events, and time | decoherence |
| | | to-point links | variations; unique | detectable with |
| | | | entanglement | threshold (ms) and |
| | | | modalities sensitivity | objective (us) |
| | | | to unique channel | resolution |
| | | | conditions | |
| | | | (polarization, time, | |
| | | | frequency, phase); | |
| | | | profiles correlate with | |
| | | | sources of disturbance | |
| | | | (classification) | |

DV sources of entanglement are particularly good at detecting discrete events that may compromise the integrity of quantum information. This makes them useful for establishing unconditionally secure bi-directional and unidirectional quantum links. However, they are, by their very nature, statistical, and generally require extended periods of integration to realize desired levels of security. As such, they are well-suited to security-related applications that can tolerate long integration times.

CV sources of entanglement are generally brighter than their DV counterparts, making them well-suited to high loss (long range) propagation in fiber and through free space. The brightness also reduces integration time, making decoherence events detectable in real-time, and opens the possibility of detecting reflections and ranging to the locations of disturbances in fiber, and over free-space links. The temporal variations/profiles, in turn, can be used to discriminate between natural versus human-made disturbances, allowing for classification of events.

Moreover, the CV channels are capable of being modulated, and therefore carrying information in ways that are inherently covert to classical modes of detection. This allows CV channels to be used for low-rate Command and control (C2) data communications, including sharing of unique node identifiers. C2 is often used by attackers to retain communications with compromised systems within a target network. They then issue commands and controls to compromised systems (as simple as a timed beacon, or as involved as remote control or data mining). This combined with traditional IPv4 (ARP) and IPV6 (SNDP) address resolution protocols, can be used to counter rogue/counterfeit nodes from accessing a quantum-hardened network.

Finally, DV and CV sources of entanglement come in many subtypes, including polarization, time-energy, orbital, etc. Each of these subtypes is susceptible to unique types of disturbances, such as polarization, time-frequency, and phase decoherence. Channels carrying both DV and CV streams of entangled photons can simultaneously detect a broad range of disturbances, ranging from discrete to nearly continuous, and subtype specific. In combination, these measures can be used to classify the types of disturbances, and, most importantly, separate security events from natural/environmental degradations and unintentional interference.

The ability to maximize the probability of attack detection, while simultaneously minimizing false alarms is generally limited by the number and quality of measures available to detect such attacks. Detection of rogue/counterfeit nodes and eavesdropping and route injection is highly dependent on the ability to detect time-based anomalies, and changes in signal quality (brightness, noise levels, and distortions in phase, frequency, and polarization, and BERs).

In addition, there is the added complexity of having both all-quantum and all-classical nodes internetworking. This means the all-classical nodes are disadvantaged, and secure communications over them can be compromised. In fact, secure communications over the all-quantum nodes may be impossible with persistent denial-of-service (DoS) attacks. Thus, the all-quantum nodes can be the primary means to establish the secure routes, and those routes can be restricted when compared with the larger set of routes available over a topologically similar all-classical network.

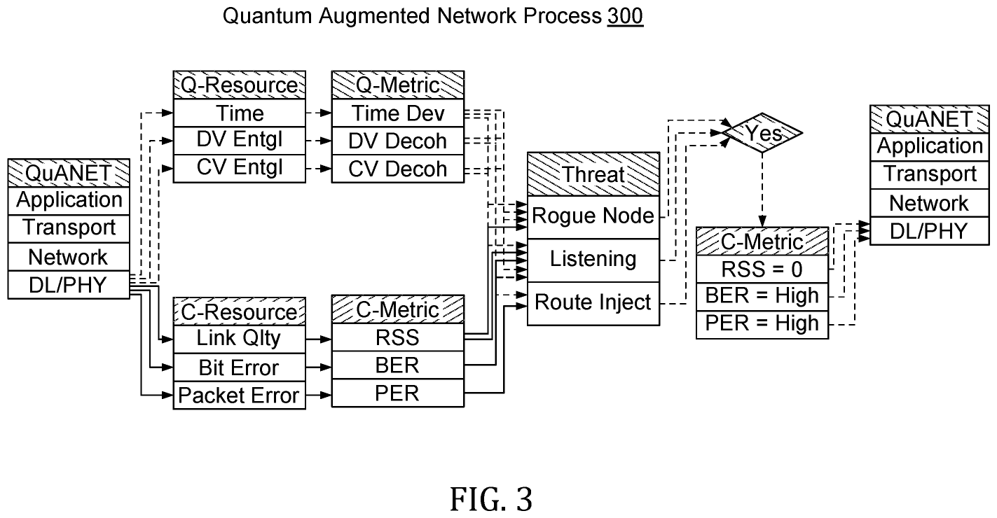

Multiple, complementary measures of point-to-point and peer-to-peer link characteristics can be fused across both all-quantum and all-classical nodes to enhance the probability of attack detection, reduce false alarms, and ultimately to determine optimal secure routes for communications (see Table 2). While the ability to detect attacks over the all-quantum point-to-point links is substantially better than what can be done over all-classical links, topological analysis is used to infer peer-to-peer performance and security concerns. The inference is effectively a form of quantum tomography, where measurements are performed over a small set of point-to-point and peer-to-peer links, to determine if security may have been compromised. If enough measurements are made over intersecting but otherwise complementary links, attacks can be both detected and located, even over all-classical point-to-point links embedded in larger peer-to-peer routes. These quantum tomographic measurements are used to form a topological view of the network, and artificial intelligence/ machine learning (AI/ML) are used to help determine when and where these attacks are occurring, and what routes are available for optimal secure communications. A quantum augmented network process 300, implementing these quantum tomographic references, is flow charted in FIG. 3.

TABLE 2
TA3 Quantum Augmentation, Benefits & Metrics.

| | Classical | Quantum | | Algorithmic |
|---|---|---|---|---|
| Metric | Limitation | Augmentation | Benefit | Measures |
| Attack | Lack of real- | Real-time detection | Real-time | 1) Fusion of detected |
| Verification | time detection | of anomalies through | identification of | events (discrete & |
| | of events over | time-tagging, and | anomalies, and | continuous) |
| | point-to-point | detection of discrete | classification of | 2) Use of AI/ML to |
| | and peer-to- | and continuous | disturbances will | classify events to |
| | peer links | variations in | improve probabilities | maximize PAD, and |
| | | decoherence across | for positive attack | minimize FA |
| | | point-to-point and | detection (PAD) & | |
| | | peer-to-peer links | reduce false alarms | |
| | | | (FA) | |
| Route | Lack of real- | Quantum network | Use of multiple | 1) Topological/ |
| Determination | time | tomography | network resources | graph like view of |
| | assessment of | | (time, DV & CV) | network |
| | local, regional, | | measures to assess | connectivity, along |
| | and global | | point-to-point and | with time variance of |
| | states of | | peer-to-peer link | events |
| | network | | performance across | 2) AI/ML pattern |
| | | | local, regional, and | recognition to |
| | | | global portions of | determine optimal |
| | | | network; Resultant, | secure route(s) |
| | | | real-time assessment | |
| | | | of state of network | |
| | | | available to determine | |
| | | | optimal secure | |
| | | | route(s) for network | |
| | | | traffic | |

While networked atomic clocks can provide for state-of-the art location of anomalies, more information can be needed to accurately characterize the anomalies. Quantum sensors can be used in many circumstances to further characterize faults and even determine causes. For example, Rydberg atoms, that is, atoms with electrons at energy levels associated with high principal quantum numbers, function as dipoles to sensitively detect magnetic and electric fields. They can be used to detect fields in or around nodes and transmission lines. See U.S. patent application Ser. No. 17/690,577 to Anderson et al. entitled “WIDEBAND TUNABLE RYDBERG MICROWAVE DETECTOR”.

As shown in FIG. 1, quantum sensors 116 are coupled to respective atomic clocks 114 so that quantum sensors 116 can be activated and deactivated at precise times. “Respective”, in this context, means “in the same grid node”. This can mean that atomic clocks 114 provide for precise timing of laser pulse durations and/or other phenomena used to control quantum states of atoms such as rubidium 87 and cesium 133 serving as sense elements that sense and store sensed parameter values. Quantum sensors 116 are also coupled to respective quantum network interfaces 112. Thus, sensor readings can be shared across grid nodes 102, 104. Thus, quantum sensor data can be collected from within a grid node or across a power grid or a neighborhood of a power grid. The collected data can be analyzed, e.g., to determine a state of the node, neighborhood, or grid. This analysis can involve quantum tomography or other complex processes requiring a computer.

The present invention provides for the inclusion of quantum computers systems 118 in grid nodes 102 and 104, etc. Each quantum computer system 118 can be coupled to a respective atomic clock 114 for precise timing. In addition, quantum computer systems 118 can be coupled to respective quantum sensors 116 and respective quantum network interfaces 112 for receiving sensed data from the local grid node and/or from other grid nodes. Quantum computer systems 118 can include quantum registers populated with atoms or molecules.

In general, quantum tomography involves using a set of entangled atoms as sensors repeatedly to acquire a large number of data sets. Each data set is rotated or otherwise manipulated according to a respective one of universal operators to obtain respective rotated data sets. These rotated data sets are then combined to provide an estimate of a quantum state of a phenomenon being sensed in a manner roughly analogous to a computer-aided tomography system assembles a three-dimensional image from a set of two-dimensional scans.

Advantageously, the atoms in the quantum registers can be of a type that is also used in sensors 116 and atomic clocks 114, e.g., alkali metal atoms such as rubidium 87 and cesium 133, all of which can make use of their Rydberg states. In this case, the atoms can be located in a quantum register when used for sensing or they can be transported, e.g., using optical tweezers, while storing sense data into a quantum register. In either of these cases, the atoms used for sensing can also be used as memory elements of a quantum computer used to manipulate the sense data in the quantum domain. In some embodiments, sense data from remote nodes can be encoded into photons and then transferred to atoms in the destination node that are also used as quantum memory elements. A quantum register including atoms used as both sensors and compute elements in the context of quantum tomography is disclosed in U.S. patent Ser. No. 17/690,577 to Anderson et al., filed Mar. 9, 2022, and entitled “SENSE-PLUS-COMPUTE QUANTUM-STATE CARRIERS”.

As explained above, the present invention provides for enhanced detection and characterization of power-grid anomalies. By distributing these enhanced capabilities among power grid nodes, the present invention helps ensure the survival of those capabilities even in the face of multiple failures. An important next step is to determine how to respond to a detected failure. For example, it would be helpful to determine a way to re-route electrical power around a failed node or transmission line.

Determining optimal responses to fault conditions can involve complex computations, the responses are typically pre-calculated using a process known as contingency analysis. Contingency analysis typically involves determining the state of a power grid, identifying potential faults, and determining optimal responses to those faults. The result of a conventional contingency analysis can be thought of as a look-up table for which the input is the actual fault and the output is the pre-calculated response. Whereas contingency analyses are conventionally performed using a classical computer, the present invention provides for leveraging quantum computer systems to perform contingency analyses more quickly and adding a capability of real-time contingency analysis in response to an actual fault.

The ever-growing US power grid brings with it many engineering and computational challenges. The US electric grid currently powers nearly 130 million households, and it is therefore essential to ensure that its availability and operation are not interrupted by environmental factors and cybersecurity threats. The present invention provides a path towards a quantum advantage in utilities security through a hybrid quantum-classical algorithm for performing power system contingency analysis. The core of the quantum advantage lies in a Hybrid Multiple Phase Estimation Algorithm (HMPEA), which can be applied to solve a linearized model of power flow in the DC limit of an energy grid. HMPEA provides a more realistic approach to quantum contingency analysis than standard algorithms such as HHL. To this end, quantum computers are integrated into the power grid to facilitate these computations at the edge, resulting in an exponential speed up in contingency analysis calculations and ultimately ensuring a more secure grid.

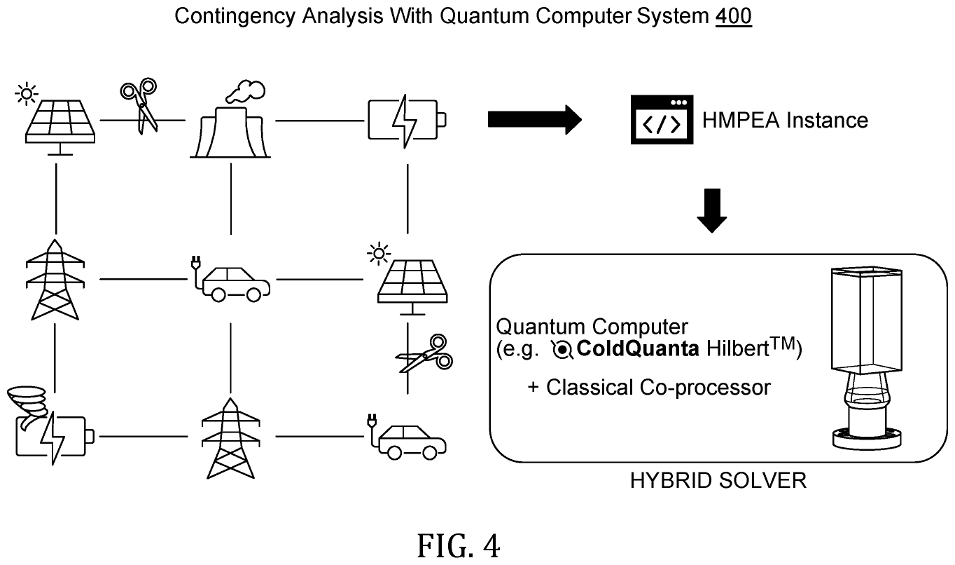

The fundamental way to measure the robustness of the power grid is through contingency analysis. A contingency is a change in the state of a power system due to the failure or loss of an element such as a generator, transformer, or transmission line. The purpose of contingency analysis is to evaluate a power system and identify potential breakages or overloads that could endanger its functioning. In the context of grid cybersecurity, hostile state actors or rogue hackers can target specific high load buses or generators in an attempt to destabilize the energy grid. Contingency analysis therefore uses a computer simulation to evaluate the effects of removing individual elements from a power system to provide for planning for such crises and building a more robust power grid. Through modeling and numerical simulations, contingency analysis provides for identification of vulnerabilities in a power system, evaluation of the consequences of failures, and informing strategies for making the energy grid more robust. As graphically represented in FIG. 4, HMPEA uses a hybrid of classical and quantum computing to address contingency analysis.

While AC is the main form of power grid transmission, DC is useful for high voltage transmission. Written in a standard form, the DC power flow is represented by the linear equation:

$$P = M θ \qquad ( 1 )$$

where P is a vector that captures power flow, M is a matrix constructed from known power system characteristics (namely, voltages and susceptance), and θ is a vector of voltage phase angles. The time to solve the inverse problem of solving for θ scales unfavorably with the size of the power system in question, making this problem intractable for large systems such as the US power grid. The difficulty of this inversion problem has motivated research into alternative techniques, for example, based on Power Transfer and Line Outage Distribution Factors (PTDFs and LODFs), but quantum computing provides for an exponential speedup for contingency analysis. While the foregoing emphasizes DC power-grid transmissions, AC equations can be linearized into a form similar to Eq. 1.

The prior-art quantum algorithm for solving a linear system of equations is known as HHL (named after Harrow, Hassidim, and Lloyd). However, capturing the advantages of this algorithm is a major challenge. For large matrices such as the admittance matrix of a power grid, it is impossible to perfectly encode its eigenvalues as a finite-bit binary number. Applying HHL under imperfect phase estimation to the DC power flow calculation requires huge qubit resources for accuracy consideration, reducing its applicability, at least in a NISQ context. For one, the reliance of HHL on quantum phase estimation means that its qubit requirements grow unfavorably with the desired precision of its output. Furthermore, the HHL algorithm does not directly provide the solution vector, θ, to a linear system of equations. Instead, HHL only yields estimates of scalar functions that are quadratic in θ, i.e., f_{F}A(θ)=θ^{τ}Fθ for a chosen matrix F.

One hybrid algorithm, known as the Hybrid Multiple Phase Estimation Algorithm (HMPEA), uses multiple imperfect phase estimation modules to achieve high accuracy phase estimation and thus can be used to solve contingency analysis. Given an equation of the form P=M0, the HMPEA algorithm accepts power flow P and power matrix M as inputs and writes an estimate of voltage phase-angle vector θ to a classical bit register, where the quality of the estimate is controlled by the quantity of quantum resources that are available. In contrast to HHL, HMPEA reduces the qubit requirements for phase estimation by executing many sequential phase estimation modules over a smaller qubit register. This tradeoff essentially reduces the size of the qubit register at the cost of increasing runtime, while still providing an exponential speedup. Thus, power grids can be equipped with quantum computers (with classical co-processors) that efficiently and periodically perform contingency analysis.

The total real (as opposed to reactive) power Pₖ at node k in an energy grid is described by the real power flow equation:

$${P}_{k} = {\sum }_{j = 1}^{N} \vert {V}_{k} \vert \vert {V}_{j} \vert [ {G}_{k j} cos ( {θ}_{k} - {θ}_{j} ) + {B}_{k j} sin ( {θ}_{k} - {θ}_{j} ) ] \qquad ( 2 )$$

where Vₖ is a voltage, Gₖⱼ is a conductance, Bₖⱼ is a susceptance, and θₖ−θⱼ is the difference in voltage phase angle between nodes k and j. Though nominally non-linear in θ, Eq. 2 can be linearized under a reasonable set of assumptions for a DC power system. The assumptions and linearization are discussed below.

Assumption 1 The resistance of transmission circuits is significantly less than the reactance. In a real-world power system, resistance tends to be 10-20 times lower than reactance. The impedance Z and admittance Y can be expressed in terms of the resistance R, reactance X, conductance G, and susceptance B by

$$Z = R + iB \qquad ( 3 )$$

$$Y = G + i B$$

Solving the relationship Z=1/Y, for G and B yields:

$$G = \frac{R}{{R}^{2} + {X}^{2}} , B = \frac{- X}{{R}^{2} + {X}^{2}} \qquad ( 4 )$$

which implies that G→0 when R<<X. This assumption allows us to reduce the power equations to

$${P}_{k} \approx {\sum }_{j = 1}^{N} \vert {V}_{k} \vert \vert {V}_{j} \vert {B}_{k j} sin ( {θ}_{k} - {θ}_{j} ) \qquad ( 5 )$$

$$where {M}_{k j} = ⌈ {V}_{k} ⌉ \vert {V}_{j} \vert {B}_{k j} .$$

Assumption 2 The voltage phase difference between any two nodes in the transmission circuit is small. This assumption is equivalent to considering the DC limit for a power grid, and allows us to make the small angle approximation:

$${P}_{k} \approx {\sum }_{j = 1}^{N} \vert {V}_{k} \vert \vert {V}_{j} \vert {B}_{k j} sin ( {θ}_{k} - {θ}_{j} ) = {\sum }_{j = 1}^{N} {M}_{k j} {θ}_{j} \qquad ( 6 )$$

$$where {M}_{k j} = - ⌈ {V}_{k} ⌉ \vert {V}_{j} \vert {B}_{k j} ( 1 - {δ}_{k j} ) ,$$

$$with {δ}_{k j} = 1 if k = j and 0 otherwise .$$

The Hybrid Multiple Phase Estimation Algorithm (HMPEA) provides for leveraging the power of quantum computation to solve the DC power flow equation for contingency analysis. As with HHL, the core of HMPEA is a subroutine for quantum phase estimation. Given a (unitary) matrix U and an eigenvector ψ for which U ψ=e^{iθ}ψ, quantum phase estimation provides an estimate of the phase θ. An HMPEA circuit consists of several hybrid single phase estimation algorithm (HSPEA) modules, designed to perform robust phase estimation in an imperfect, noisy setting.

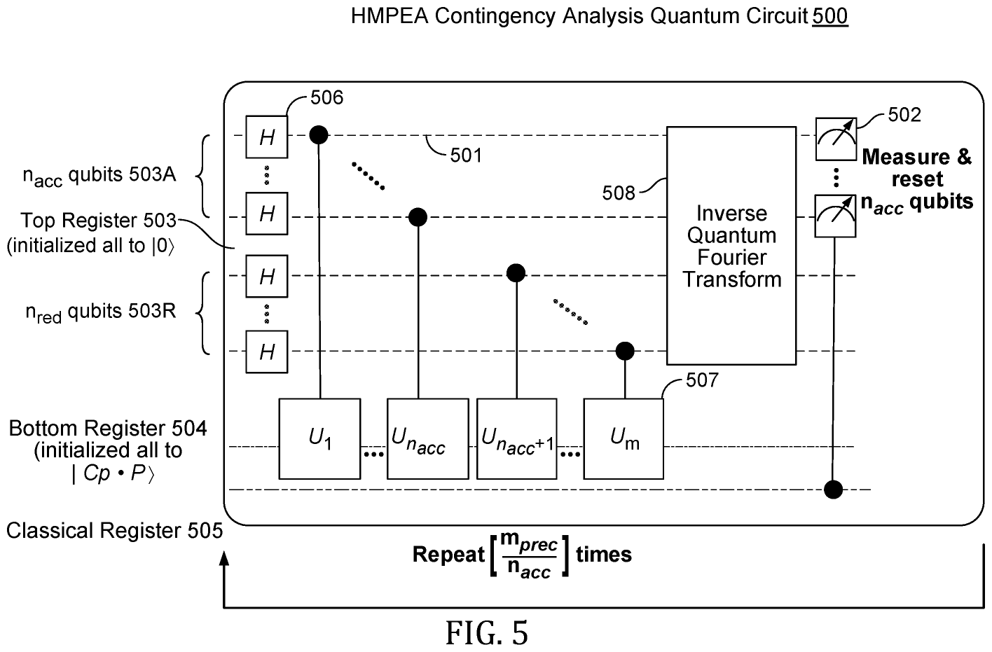

FIG. 5 shows an HMPEA circuit 500 that solves Eq. 1. Circuit 500 represents the progression of the algorithm from left to right, with each horizontal line 501 corresponding to a single qubit. Each qubit is acted on by gates, represented by labeled blocks. Blocks 502 with dials on them represent measurement operators, which return a measurement of the qubit at that point in the circuit. The HMPEA circuit setup has three registers (i.e., arrays of qubits): top, bottom, and classical. The top register 503 consists of n_{acc} accuracy qubits 503A and n_{red} redundancy qubits 503R, which respectively determine the accuracy and success rate of phase estimation. The bottom register 504 is always initialized to the normalized power state (|Cₚ·P [symbol] ) for subsequent quantum data processing. Finally, the classical register 505 takes the phase approximations made by the qubit registers and makes an approximation of θ.

Qubits in top register 503 are initially acted upon by Hadamard gates 506 (represented by blocks labelled H), which prepares the top register qubits in a uniform superposition of all bitstrings. Each of these qubits then controls a unitary operator 507 that acts on the bottom register. The matrix M is used to generate these unitary matrices, given by Uₖ=e^{2πi}M2^{m-k}, where m=n_{acc}−n_{red} is the number of qubits in the top register.

All qubits in the top register are then acted upon by the inverse quantum Fourier transform 508 (QFT; or simply a discrete Fourier transform applied to quantum bits), before the n_{acc} accuracy qubits 503A are measured, and the measurement results are written to classical register 505. This sequence constitutes a single-phase estimation module, which is repeated [m_{prec}/n_{acc}] times (writing measurement results to a new set of classical bits each time) to achieve a precision of m_{prec} in the final output of the algorithm, where measurement precision corresponds to the number of decimal places in the final output of the algorithm.

Running all phase estimation modules prepares the bottom register into the eigenvector uⱼ of M, whose corresponding eigenvalue λⱼⁿ^{_{acc}} (with precision n_{acc}) and overlap pⱼ with P(i.e., pⱼ=uⱼ^{τ}P) can be read off of the measurement results in the classical register. This data is then combined to obtain an estimate \tilde{θ} of θ:

$$\tilde{θ} = {\sum }_{j = 1}^{N} \frac{{p}_{j} {u}_{j}}{{λ}_{j}^{{n}_{acc}}} \qquad ( 7 )$$

The foregoing analysis for a single contingency can be scaled up to a multi-contingency analysis. For a network with N nodes, the matrix M appearing in the power flow equations has dimensions N×N. Contingency analysis for the knockout of node k entails eliminating the k^{th} row and k^{th} column of this matrix, leading to N possible knockout configurations.

More generally, knocking out n nodes leads to

$$( \begin{matrix}N \\ n\end{matrix} ) = \frac{N !}{n ! ( N - n ! )} ∼ {N}^{n}$$

configurations, which rapidly becomes classically intractable to analyze. However, encoding the solutions to these configurations into an exponentially large state space of a qubit register results in a physical memory footprint that only scales as O(log(Nⁿ))=O(n log(N)). This strategy for contingency analysis allows for estimating functions of θ in multi-contingency scenarios with only O(log(N)) qubits. Using HMPEA as described above can require a large amount of classical memory, but without the need to perform matrix inversion for an extensively large data set.

An important consideration is that of computational complexity. HHL achieves an exponential speed up over classical approaches to solving linear equations. Given an N-node grid whose susceptibility matrix B has sparsity sand condition number k, in the best-case scenario performing DC contingency analysis on a classical computer has time complexity O(Nks log(1/ϵ)), where ϵ is the acceptable error tolerance. HHL finds a solution with complexity O(log(N)s²k²/ϵ). HMPEA uses m_{prec}/n_{acc} phase estimation modules, where m_{prec} is the desired level of precision (say, the number of digits) in the final output, with an overall time complexity of O((m_{prec}/n_{acc})log(N)s²k²/ϵ). The reduction from O(N) to O(log N) in going from classical to quantum methods is an exponential speedup that can enable analyzing otherwise intractable energy grids. Moreover, the capability to reduce qubit number (potentially at the cost of circuit depth) for HMPEA makes it more viable for small-scale quantum devices, bringing a quantum advantage in contingency analysis feasible for practical deployment.

Grid modernization and the move to clean energy is undoubtedly a step in the right direction, but it is not without its challenges. More power generators and transmission lines mean more threats—both natural and cybernetic—to a power grid. Efficient execution of processes such as contingency analysis is essential to ensure that the power grid is always available. Quantum computing provides the tools to ensure these calculations can be executed faster than ever, while still achieving high accuracy. HMPEA, in particular, can outperform classical techniques in the NISQ era.

Computation-intensive grid security applications include state estimation and contingency analysis. First, with quantum computers deployed alongside ultra-accurate clocks, State Estimation, e.g., using quantum tomography, can be performed at the edge instead of the existing Supervisory Control And Data Acquisition (SCADA) centralized architecture, which is critical to ensuring grid resilience. Efficient quantum tomography protocols and quantum computers with integrated quantum sensors are described in detail in U.S. patent application Ser. No. 18/205,434 entitled “SENSE-PLUS-COMPUTE QUANTUM-STATE CARRIERS” to Perlin et al., filed Jun. 2, 2023. Second, the above-mentioned breakthroughs in quantum sensing and machine learning can be leveraged to further improve timing accuracy and synchronization across the energy grid, and to perform quantum data processing of local sensor data to extract grid features.

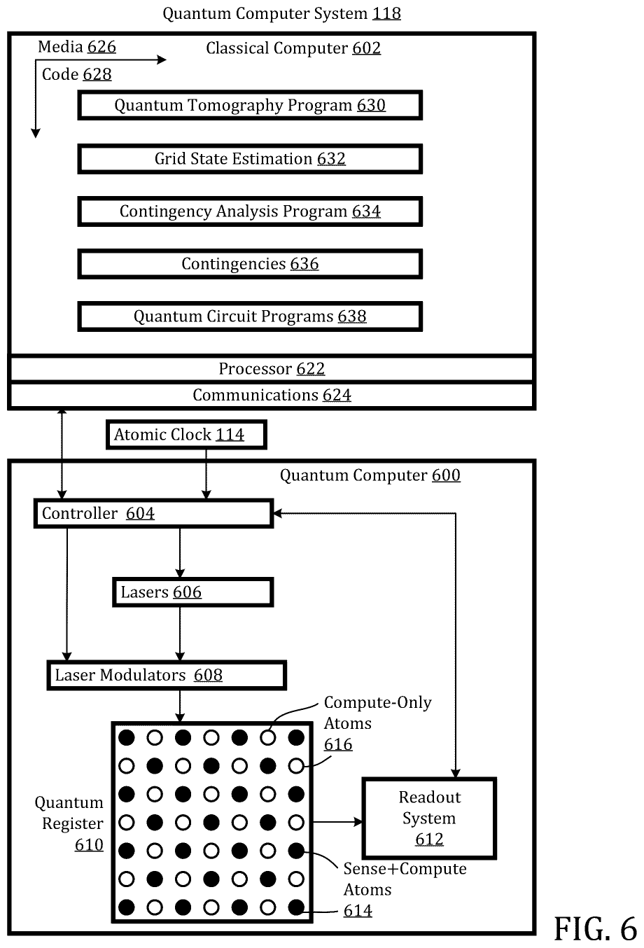

As shown in FIG. 6, quantum computer system 118 includes a quantum computer 600 and a classical computer 602. Quantum computer 600 includes a controller 604, lasers 606, laser modulators 608, a quantum register 610 and a readout system 612. Lasers 606 provide light of resonant and other frequencies for effecting energy-level transitions for atoms in quantum register 610. Laser modulators 608 are used to activate, deactivate, and steer laser beams provided by lasers 606. Controller 604 controls lasers 606 and laser modulator 608 using atomic clock 114 for a time base. Quantum register 610 includes sense-plus-compute atoms 614 and compute-only atoms 616 as disclosed in U.S. patent application Ser. No. 18/205,434, referred to above.

Classical computer 602 includes a processor 622, communications devices 624 (including input/output devices), and non-transitory computer-readable media 626. Media 626 is encoded with code 628 that, when executed using processor 622, implements processes defined by programs including quantum tomography program 630 that yields a grid state estimate 632, a contingency analysis program 634 that yields contingencies (grid reconfigurations in the event of faults), and quantum-circuit programs that, when executed, serve as instructions for quantum computer system 600. Quantum tomography program 630 and contingency analysis program 634 also include dedicated quantum circuits.

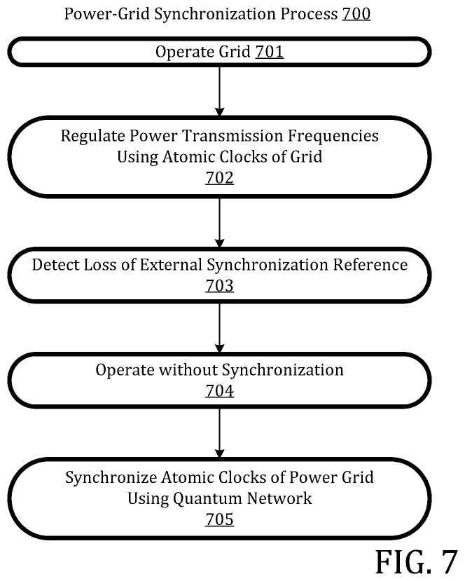

A power-grid synchronization process 700, flow-charted in FIG. 7, includes operating a power grid at 701. At 702, power transmission frequencies are regulated based on a time base provided by atomic clocks included in grid nodes of the power grid. In the event of a loss, at 703, of an external synchronization reference, e.g., provided by GPS, the power grid timing can be provided by the stable atomic clocks, e.g., for a day or so at 704. At 705, the atomic clocks are synchronized to each other over a quantum network of the power grid. This internal synchronization permits the grid to operate for a year or more. In addition, many operations benefit from the internal synchronization of the atomic clocks. For example, traveling wave fault detection (TWFD) can locate faults with much greater precision once the atomic clocks are synchronized.

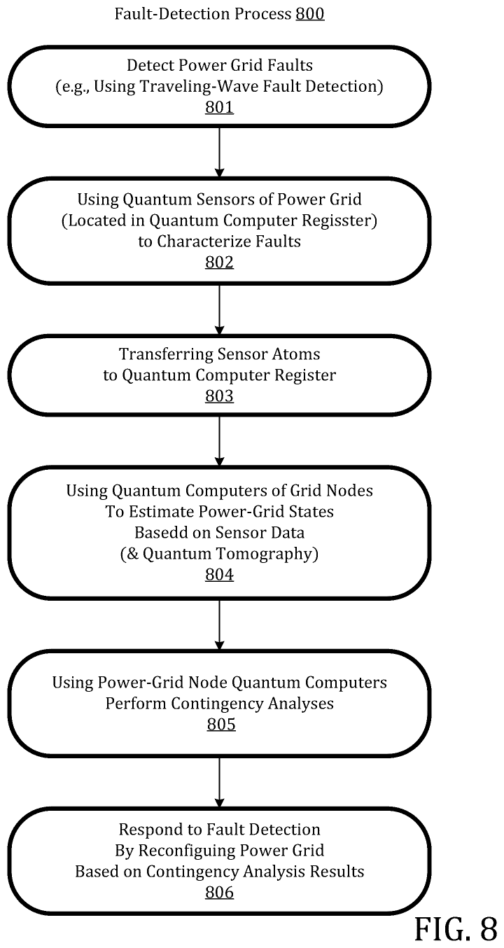

For example, a fault detection process 800, flow-charted in FIG. 8, begins with detecting power grid faults at 801, e.g., using TWFD. While TWFD can locate faults, quantum sensors, e.g., for detecting magnetic and electric fields can help identify the cause of or otherwise characterize the faults. Sensor data collected by the quantum sensors can be correlated with TWFD data using quantum computer systems of respective power-grid nodes. In some embodiments, at 803, dual use sense and compute atoms are included in a quantum register of a quantum computer during sensing. In other embodiments, the atoms can be external to the register during sensing, and then transported into the quantum register already encoded with sense data. In other cases, the quantum states representing sense data can be transferred to the atoms in the quantum register in some other way.

At 804, quantum computer systems are used to estimate power-grid states, e.g., including switch configuration for routing electrical power through transmission lines. In some scenarios, a power-grid state is estimated using quantum tomography. Once the power-grid state is estimated, at 805, a contingency analysis can indicate changes in the power-grid state to address potential faults. Thus, at 806, when a fault is detected, the power grid can be reconfigured based on contingency analysis results.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Although the foregoing embodiments have been described in some detail for purposes of clarity of understanding, the invention is not limited to the details provided. There are many alternative ways of implementing the invention. The disclosed embodiments are illustrative and not restrictive.

Herein, all art labelled “prior art”, if any, is admitted prior art; any art not labelled “prior art” is not admitted prior art. The embodiments described above, variations thereupon and modification thereto are provided for by the present invention, the scope of which is defined by the accompanying claims.

What is claimed is:

1. A power grid node comprising:
an atomic clock;
a quantum network interface configured to:
connect the atomic clock to a quantum network;
receive quantum synchronization input;
the atomic clock configured to synchronize itself with other atomic clocks based on the received quantum synchronization input; and
a quantum sensor configured to measure an electric field as electric-field data, wherein the electric-field data is transferred over the quantum network to other power grid nodes.

2. The power grid node of claim 1, wherein the received quantum synchronization input comprises a first number of entangled pulses, wherein each entangled pulse comprises a second number of squeezed particles.

3. A power grid comprising:
grid nodes, each of the grid nodes being a member of a set including power plants, renewable power sources, and substations, the grid nodes including respective atomic clocks; and
power transmission lines electrically coupling each of the grid nodes to at least one other of the grid nodes.

4. The power grid of claim 3, further comprising a quantum network, the grid nodes including respective quantum network interfaces coupling respective atomic clocks to the quantum network.

5. The power grid of claim 4, wherein the quantum network interfaces are configured to synchronize the atomic clocks across the quantum network.

6. The power grid of claim 5, further comprising quantum sensors configured to measure electric fields at the grid nodes, the quantum sensors being coupled to respective quantum network interfaces so that electric-field data generated by the quantum sensors can be transferred to grid nodes other than their respective grid nodes.

7. The power grid of claim 6, wherein the quantum sensors are coupled to the atomic clocks so that the quantum sensors can be activated and deactivated at certain times.

8. The power grid of claim 7, further comprising quantum computer systems included in respective power grid nodes, the quantum computer systems being coupled with the respective quantum network interfaces, the atomic clocks and the quantum sensors, the quantum computer systems being configured to estimate or determine grid states of the power grid based on information obtained from the quantum sensors.

9. The power grid of claim 8, wherein the quantum computer systems are configured to estimate the grid states using quantum tomography.

10. The power grid of claim 9, wherein the quantum computer systems have respective quantum registers populated at least in part by compute atoms having a first atomic number and a first atomic weight.

11. The power grid of claim 10, wherein at least some of the compute atoms are sensor atoms of the quantum sensors and are included in the quantum sensors.

12. The power grid of claim 10, wherein at least some of the compute atoms are sensor atoms of the quantum sensors and encode sense data captured before they were transported into the quantum registers.

13. A power-grid process comprising:
operating a power grid having plural grid nodes that are members of a set including power plants, renewable power sources, and substations, the grid nodes including respective atomic clocks; and
regulating power transmission frequencies of power transmissions between the grid nodes using the atomic clocks.

14. The power-grid process of claim 13, further comprising operating the power grid without synchronizing the atomic clocks to an external time reference.

15. The power-grid process of claim 13, further comprising synchronizing the atomic clocks to each other using a quantum network of the power grid.

16. The power-grid process of claim 13, further comprising synchronizing the atomic clocks to an external time reference.

17. The power-grid process of claim 13, further comprising using quantum sensors of the grid nodes to characterize electric fields at the grid nodes to yield electric-field data.

18. The power-grid process of claim 17, further comprising using quantum computer systems of the grid nodes to provide state estimates of states of the power grid based on the electric-field data.

19. The power-grid process of claim 18, wherein the quantum computer systems are configured to compute the state estimates using quantum tomography.

20. The power-grid process of claim 18, further comprising importing at least some of the electric-field data in the quantum computer systems by transferring atomic sensor elements of the quantum sensors into quantum registers of the quantum computer systems.
